(19) United States
(12) Patent Application Publication
(10) Pub. No.: US 2017/0371684 A1
(43) Pub. Date: Dec. 28, 2017

(54) PIN CONTROL METHOD AND DEVICE

(71) Applicant: Beijing Xiaomi Mobile Software Co., Ltd., Beijing (CN)

(72) Inventors: Kangxi TAN, Beijing (CN); Li HE, Beijing (CN); Jun ZHANG, Beijing (CN)

(21) Appl. No.: 15/633,785

(22) Filed: Jun. 27, 2017

(30) Foreign Application Priority Data
Jun. 28, 2016 (CN) PCT/CN2016/087473

(51) Int. Cl. G06F 9/44; G06F 1/32

(52) U.S. Cl. CPC G06F 9/4418; G06F 1/3287

(57) ABSTRACT

A pin control method and device are provided. The method may be applied to a first chip and the first chip includes: a sleep pin connected with a wakeup pin on a second chip, a Request To Send (RTS) pin connected with a Clear To Send (CTS) pin on the second chip, a Receive Data (RXD) pin connected with a Transmit Data (TXD) pin on the second chip. The method includes: receiving, by the sleep pin, a data sending signal sent by the second chip; setting the RTS pin into an effective state according to the data sending signal; receiving, by the RXD pin, data sent by the second chip, the RXD pin being in the effective state when the RTS pin is in the effective state; receiving, by the sleep pin, a transmission completion signal sent by the second chip; setting the RTS pin into an ineffective state according to the transmission completion signal; and determining, according to a current running condition, whether to enter a sleep state.

### CROSS-REFERENCE TO RELATED APPLICATIONS

This application is filed based upon and claims priority to International Patent Application No. PCT/CN2016/087473, filed on Jun. 28, 2016, the entire contents of which are incorporated herein by reference.

### TECHNICAL FIELD

The present disclosure generally relates to the field of electronic equipment, and more particularly to a pin control method and device.

### BACKGROUND

A master chip and peripheral chips are arranged in a main board of a television. The master chip may be connected with the peripheral chips through multiple pins, and each peripheral chip is configured to implement a respectively corresponding function. For example, a Bluetooth chip is configured to implement a Bluetooth data transmission function. A Clear To Send (CTS) pin of the master chip is usually connected with a Request To Send (RTS) pin of the peripheral chip, and a Transmit Data (TXD) pin of the master chip is usually connected with a Receive Data (RXD) pin of the peripheral chip. In one case, when the peripheral chip is in a working state, the RTS pin is configured into an effective state. The master chip may send data to the peripheral chip through the TXD pin, and the peripheral chip may receive the data through the RXD pin. In another case, when the peripheral chip is in a sleep state, the RTS pin is in an ineffective state, and the RXD pin in the peripheral chip does not receive any data. When there is no demand for data transmission between the master chip and the peripheral chip and the peripheral chip has no other work task, the peripheral chip may be in the sleep state.

In a scenario where a grounding design of the main board is relatively poor, the master chip may not effectively shield an interference signal. When the television receives an instantaneous high voltage (such as static electricity of a human body) and the peripheral chip is in the working state, the master chip may also transmit the interference signal to the peripheral chip through the TXD pin, which may cause a working abnormity of the peripheral chip.

### SUMMARY

According to a first aspect of the embodiment of the present disclosure, a pin control method is provided, which may be applied to a first chip. The first chip includes a sleep pin connected with a wakeup pin on a second chip, a Request To Send (RTS) pin connected with a CTS pin on the second chip, a RXD pin connected with a TXD pin on the second chip. The method includes: receiving, by the sleep pin, a data sending signal sent by the second chip; setting the RTS pin into an effective state according to the data sending signal; receiving, by the RXD pin, data sent by the second chip, the RXD pin being in the effective state when the RTS pin is in the effective state; receiving, by the sleep pin, a transmission completion signal sent by the second chip; setting the RTS pin into an ineffective state according to the transmission completion signal; and determining, according to a current running condition, whether to enter a sleep state.

According to a second aspect of the embodiment of the present disclosure, a pin control device is provided, which may be applied to a first chip. The first chip includes a sleep pin connected with a wakeup pin on a second chip, a RTS pin connected with a CTS pin on the second chip, a RXD pin connected with a TXD pin on the second chip. The device includes: a processor; and a memory configured to store instructions executable by the processor; wherein the processor is configured to: receive, by the sleep pin, a data sending signal sent by the second chip; set the RTS pin into an effective state according to the data sending signal; receive, by the RXD pin, data sent by the second chip, the RXD pin being in the effective state when the RTS pin is in the effective state; receive, by the sleep pin, a transmission completion signal sent by the second chip; set the RTS pin into an ineffective state according to the transmission completion signal; and determine, according to a current running condition, whether to enter a sleep state.

According to a third aspect of the embodiment of the present disclosure, a pin control device is provided, which may be applied to a second chip. The second chip includes a wakeup pin connected with a sleep pin on a first chip, a CTS pin connected with a RTS pin on the first chip, a TXD pin connected with a RXD pin on the first chip. The device includes a processor; and a memory configured to store instructions executable by the processor; wherein the processor is configured to: send, by the wakeup pin, a data sending signal to the first chip; detect, by the CTS pin, whether the RTS pin is in an effective state; send, by the TXD pin, data to the first chip if the RTS pin is in the effective state; and when data transmission is completed, send, by the wakeup pin, a transmission completion signal to the first chip for: setting the RTS pin into an ineffective state according to the transmission completion signal and determining, according to a current running condition, whether to enter a sleep state.

It is to be understood that the above general descriptions and detailed descriptions below are only exemplary and explanatory and not intended to limit the present disclosure.

### BRIEF DESCRIPTION OF THE DRAWINGS

In order to describe the technical solutions in the embodiment of the present disclosure more clearly, the accompanying drawings required by descriptions about the embodiment will be simply introduced below. Obviously, the accompanying drawings described below are only some embodiments of the present disclosure, and those skilled in the art may also obtain other accompanying drawings according to these accompanying drawings on the premise of no creative work.

FIG. 1 is a schematic diagram illustrating an implementation environment involved in a pin control method, according to a part of exemplary embodiments.

FIG. 2 is a method flow chart showing a pin control method, according to an exemplary embodiment.

FIG. 3 is a method flow chart showing a pin control method, according to an exemplary embodiment.

FIG. 4A is a method flow chart showing a pin control method, according to an exemplary embodiment.

FIG. 4B is a schematic diagram illustrating a pin control method, according to an exemplary embodiment.

FIG. 5 is a block diagram of a pin control device, according to an exemplary embodiment.

FIG. 6 is a block diagram of a pin control device, according to another exemplary embodiment.

FIG. 7 is a block diagram of a pin control device, according to an exemplary embodiment.

### DETAILED DESCRIPTION

In order to make a purpose, technical solutions and advantages of the present disclosure clearer, implementation modes of the present disclosure will be further described below with reference to the accompanying drawings in detail.

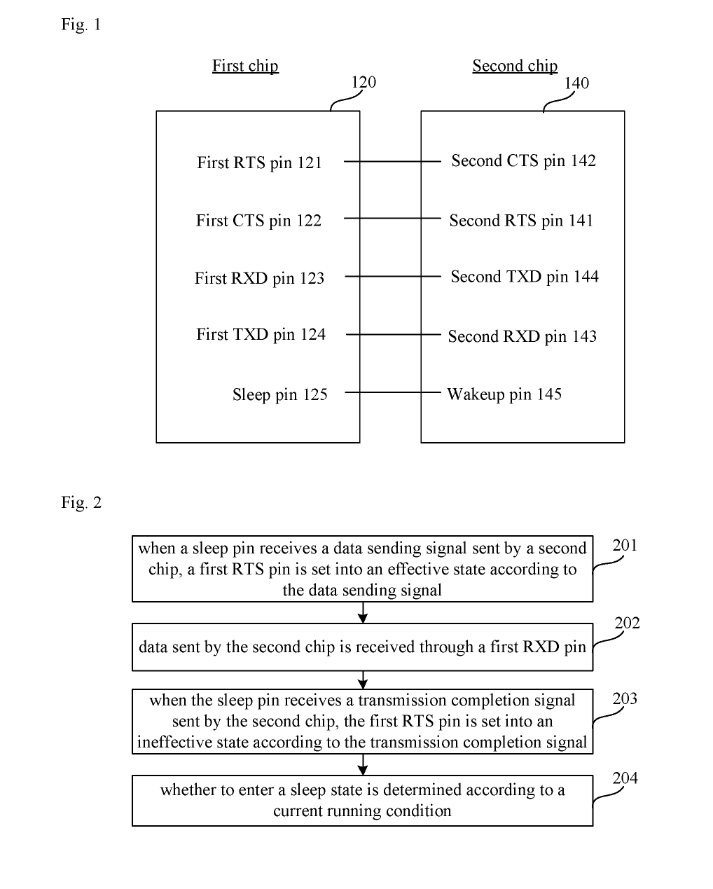

FIG. 1 is a schematic diagram illustrating an implementation environment involved in a pin control method, according to a part of exemplary embodiments. As shown in FIG. 1, the implementation environment may include: a first chip 120 and a second chip 140.

The first chip 120 includes: a first RTS pin 121, a first CTS pin 122, a first RXD pin 123, a first TXD pin 124 and a sleep pin 125.

The second chip 140 includes: a second RTS pin 141, a second CTS pin 142, a second RXD pin 143, a second TXD pin 144 and a wakeup pin 145.

The first RTS pin 121 in the first chip 120 is connected with the second CTS pin 142 in the second chip 140. The first CTS pin 122 in the first chip 120 is connected with the second RTS pin 141 in the second chip 140. The first RXD pin 123 in the first chip 120 is connected with the second TXD pin 144 in the second chip 140. The first TXD pin 124 in the first chip 120 is connected with the second RXD pin 143 in the second chip 140. The sleep pin 125 in the first chip 120 is connected with the wakeup pin 145 in the second chip 140.

The first RTS pin 121 is configured to indicate that the first chip 120 has been prepared, and the first RXD pin 123 may receive data. The second CTS 142 is configured to judge whether data may be sent to the first chip 120, that is, the second chip 140 detects whether the first RTS pin 121 is in an effective state by using the second CTS pin 142. When the first RTS pin 121 is in the effective state, the second chip 140 may send the data to the first chip 120, and the first chip 120 may also receive the data through the first RXD pin 123. When the first CTS pin 121 is in an ineffective state, the first RXD pin 123 on the first chip 120 is not allowed to receive the data.

Typically, a sleep control method includes: when the first chip 120 is in a working state, the second chip 140 sends data to the first chip 120 through the second RXD pin 144, and the first chip 120 receives the data sent by the second chip 140 through the first RXD pin 123; after transmission of data to be transmitted of the second chip 140 is completed, the second chip 140 sends a transmission completion signal to the first chip 120 through the wakeup pin 145; when the sleep pin 125 on the first chip 120 receives the transmission completion signal, whether to enter a sleep state is determined according to a current running condition of the first chip 120; if the first chip 120 determines itself to enter the sleep state according to the current running condition, the first chip 120 sets the first RTS pin 121 into the ineffective state according to the transmission completion signal, and the first RXD pin 123 does not receive the data; and if the first chip 120 determines itself to keep a working state according to the current running condition, the first RTS pin 121 on the first chip 120 is kept set into the effective state, and the first RXD pin 123 may receive the data.

A pin control method disclosed by the embodiment of the present disclosure includes that: when the first chip 120 receives the transmission completion signal sent by the second chip 140 through the sleep pin 125, the first chip 120 sets the first RTS pin 121 into the ineffective state according to the transmission completion signal; and meanwhile, the first chip 120 determines according to the current running condition whether to enter the sleep state. That is, when the first chip 120 sets the first RTS pin 121 into the ineffective state according to the transmission completion signal, the first chip 120 may be in the sleep state, and may also be in the working state.

FIG. 2 is a method flow chart showing a pin control method, according to an exemplary embodiment. The embodiment is described with application of the pin control method to a first chip 120 in an implementation environment shown in FIG. 1 as an example. The pin control method includes the following steps.

Step 201: when a sleep pin receives a data sending signal sent by a second chip, a first RTS pin is set into an effective state according to the data sending signal.

Wherein, the sleep pin is a pin connected with a wakeup pin on the second chip and the first RTS pin is a pin connected with a CTS pin on the second chip;

Step 202: data sent by the second chip is received through a first RXD pin.

Wherein, the first RXD pin is in the effective state when the first RTS pin is in the effective state, and the first RXD pin is a pin connected with a second TXD pin on the second chip.

Step 203: when the sleep pin receives a transmission completion signal sent by the second chip, the first RTS pin is set into an ineffective state according to the transmission completion signal.

Step 204: whether to enter a sleep state is determined according to a current running condition.

Typically, when a peripheral chip is in the working state, an RTS pin of the peripheral chip is in the effective state all the time. When the interference signal exists in the master chip, an RXD pin in the peripheral chip may receive an interference signal from the master chip, which may cause a working abnormity of the peripheral chip. From the above, according to the pin control method provided by the embodiment, when the sleep pin of the first chip receives the transmission completion signal sent by the second chip, the first RTS pin is set into the ineffective state according to the transmission completion signal, avoiding the working abnormity of the peripheral chip. When the sleep pin receives the transmission completion signal sent by the second chip, the first RTS pin is set into the ineffective state, which makes that the RXD pin on the first chip may not receive an interference signal existing in the second chip, no matter whether the first chip enters the sleep state. The condition of working abnormity of the first chip due to reception of the interference signal in the second chip is avoided.

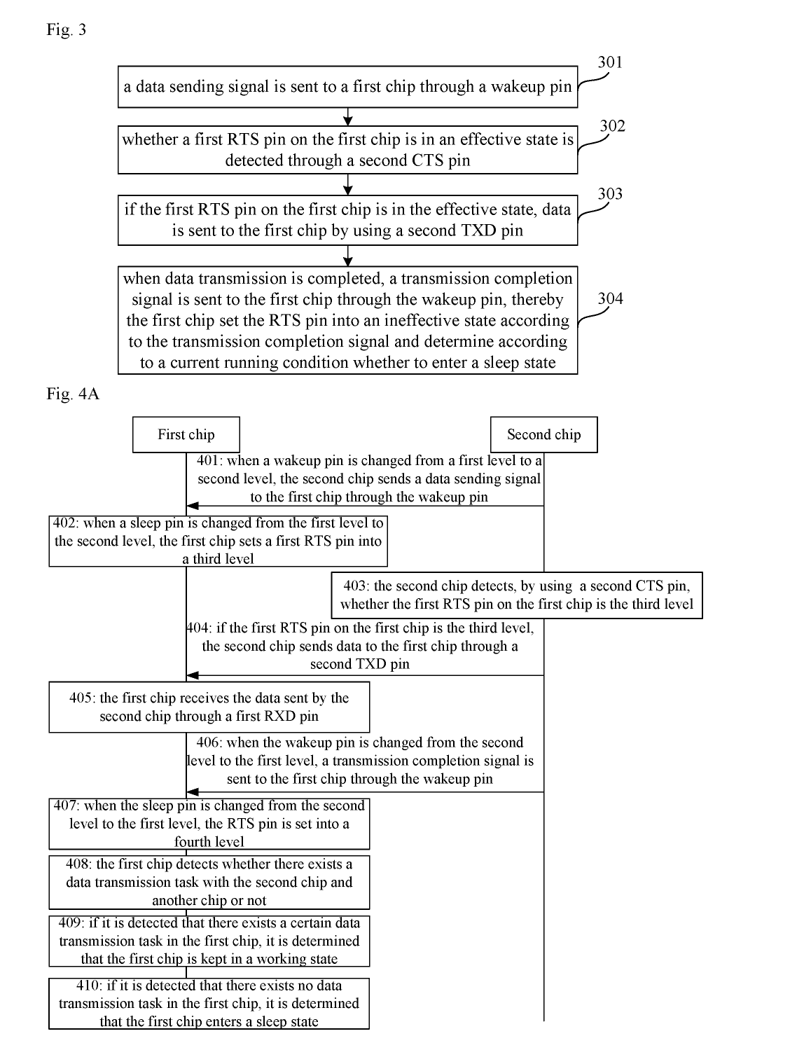

FIG. 3 is a method flow chart showing a pin control method, according to an exemplary embodiment. The embodiment is described with application of the pin control method to a second chip 140 in an implementation environment shown in FIG. 1. The pin control method includes the following steps.

Step 301: a data sending signal is sent to a first chip through a wakeup pin.

Wherein, the wakeup pin is a pin connected with a sleep pin on the first chip.

Step 302: whether a first RTS pin on the first chip is in an effective state is detected by using a second CTS pin.

Wherein, the second CTS pin is a pin connected with the first RTS pin on the first chip.

Step 303: if the first RTS pin on the first chip is in the effective state, data is sent to the first chip through a second TXD pin.

Wherein, the second TXD pin is a pin connected with a first RXD pin on the first chip.

Step 304: when data transmission is completed, a transmission completion signal is sent to the first chip through the wakeup pin for the first chip to set the RTS pin into an ineffective state according to the transmission completion signal and to determine according to a current running condition whether to enter a sleep state.

Typically, when a peripheral chip is in the working state, an RTS pin of the peripheral chip is in the effective state all the time. When the interference signal exists in the master chip, an RXD pin in the peripheral chip may receive an interference signal from the master chip, which may cause a working abnormity of the peripheral chip. From the above, according to the pin control method provided by the embodiment, when data transmission is completed, the transmission completion signal is sent to the first chip through the wakeup chip, thereby the first chip sets the RTS pin into the ineffective state according to the transmission completion signal, avoiding the working abnormity of the peripheral chip. When a sleep pin of the first chip receives the transmission completion signal sent by the second chip, the first RTS pin is set into the ineffective state, which makes that the RXD pin on the first chip may not receive an interference signal existing in the second chip, no matter whether the first chip enters the sleep state. The condition of working abnormity of the first chip due to reception of the interference signal in the second chip is avoided.

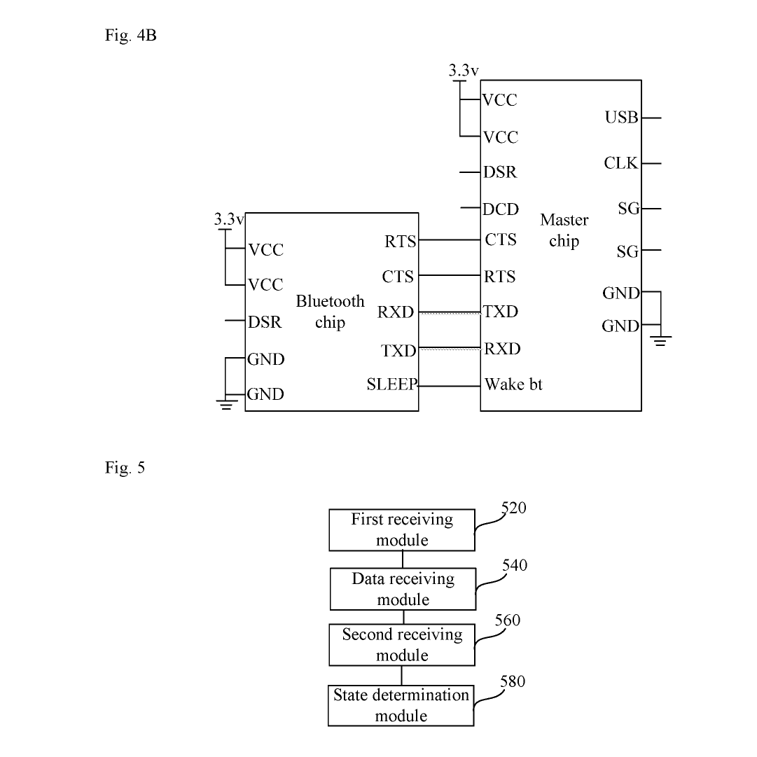

FIG. 4A is a method flow chart showing a pin control method, according to an exemplary embodiment. The embodiment is described with application of the pin control method to an implementation environment shown in FIG. 1. The pin control method includes the following steps.

Step 401: when a wakeup pin is changed from a first level to a second level, a second chip sends a data sending signal to a first chip through the wakeup pin.

Wherein, the wakeup pin is a pin connected with a sleep pin on the first chip.

When the first chip is in a working state, if the second chip is required to send data to the first chip, the wakeup pin in the second chip is changed from the first level to the second level. When the wakeup pin is changed from the first level to the second level, the second chip sends the data sending signal to the first chip through the wakeup pin. The data sending signal is configured to notify the first chip to prepare to receive the data and the second chip has a demand for data transmission.

Wherein, the first level is a high level and the second level is a low level. Or, the first level is a low level and the second level is a high level.

Step 402: when a sleep pin is changed from the first level to the second level, the first chip sets a first RTS pin into a third level.

Wherein, the first RTS pin is a pin connected with a second CTS pin on the second chip. The third level is configured to represent that the first RTS pin is in an effective state.

Since the sleep pin on the first chip is connected with the wakeup pin on the second chip, the sleep pin on the first chip is also changed from the first level to the second level when the wakeup pin on the second chip is changed from the first level to the second level. When the sleep pin on the first chip is changed from the first level to the second level, the first chip sets the first RTS pin into the third level.

When the first RTS pin on the first chip is in the effective state, a first RXD pin on the first chip may receive the data.

For example: it is supposed that the first level is a low level, the second level is a high level and the third level is a high level. When the wakeup pin of the second chip is changed from a low level to a high level, the sleep pin on the first chip is also changed from the low level to the high level; and at this moment, the first chip sets the first RTS pin into a high level. That is, the first RTS pin is set into the effective state, and the first RXD pin on the first chip may receive the data.

In the embodiment, descriptions are made only with the condition that the first RTS pin is in the effective state when being at a high level as an example. In some embodiments, the first RTS pin may also be in the effective state when being at a low level, which will not be specifically limited in the embodiment.

Step 403: the second chip detects, by using a second CTS pin whether the first RTS pin on the first chip is the third level.

Wherein, the second CTS pin is a pin connected with the first RTS pin on the first chip. The third level is configured to represent that the first RTS pin is in the effective state; and the third level is a high level or a low level.

Since the second CTS pin on the second chip is connected with the first RTS pin on the first chip, the second CTS pin on the second chip is in the effective state when the first RTS pin on the first chip is in the effective state. The second chip detects whether the first RTS pin on the first chip is in the effective state by using the second CTS pin.

In a detection process of Step 403, two kind of detection results may be obtained. If it is detected that the first RTS pin on the first chip is in an ineffective state, it is indicated that the first RXD pin on the first chip does not receive the data. If it is detected that the first RTS pin on the first chip is in the effective state, Step 404 is executed.

Step 404: if the first RTS pin on the first chip is the third level, the second chip sends data to the first chip through a second TXD pin.

Wherein, the second TXD pin is a pin connected with the first RXD pin on the first chip.

If the second CTS pin detects that the first RTS pin on the first chip is the third level, it is indicated that the first RTS pin on the first chip is in the effective state and the first RXD pin may receive the data sent by the second chip, and then the second chip sends the data to the first chip through the second TXD pin.

Step 405: the first chip receives the data sent by the second chip through a first RXD pin.

Wherein, the first RXD pin is in the effective state when the first RTS pin is in the effective state.

Step 406: when the wakeup pin is changed from the second level to the first level, a transmission completion signal is sent to the first chip through the wakeup pin.

When data transmission of the second chip to the first chip is completed, the wakeup pin in the second chip is changed from the second level to the first level. When the wakeup pin is changed from the second level to the first level, the second chip sends the transmission completion signal to the first chip through the wakeup pin, and the transmission completion signal is configured to notify that data transmission to the first chip is completed and the second chip has no demand for data transmission.

Step 407: when the sleep pin is changed from the second level to the first level, the RTS pin is set into a fourth level.

Wherein, the fourth level is configured to represent that the RTS pin is in the ineffective state; and the fourth level is a high level or a low level. Further, the fourth level is different from the third level. If the third level is a high level, the fourth level is a low level; and if the third level is a low level, the fourth level is a high level.

Since the sleep pin on the first chip is connected with the wakeup pin on the second chip, the sleep pin on the first chip is also changed from the second level to the first level when the wakeup pin on the second chip is changed from the second level to the first level. When the sleep pin on the first chip is changed from the second level to the first level, the first chip sets the first RTS pin into the fourth level.

When the first RTS pin on the first chip is in the ineffective state, the first RXD pin on the first chip does not receive any data.

For example: it is supposed that the first level is a low level, the second level is a high level and the fourth level is a low level. When the wakeup pin of the second chip is changed from a high level to a low level, the sleep pin on the first chip is also changed from the high level to the low level; and at this moment, the first chip sets the first RTS pin into a low level. That is, the first RTS pin is set into the ineffective state, and the first RXD pin on the first chip may not receive the data.

In the embodiment, descriptions are made only with the condition that the first RTS pin is in the ineffective state when being at a low level as an example. In some embodiments, the first RTS pin may also be in the ineffective state when being at a high level, which will not be specifically limited in the embodiment.

Step 408: the first chip detects whether there exists a data transmission task with the second chip or another chip.

When the sleep pin is changed from the second level to the first level, the first chip detects whether there exists a data transmission task with the second chip or another chip.

The data transmission task refers to whether the first chip is sending data to the second chip or another chip and whether the first chip is receiving data sent by the second chip or another chip.

In a detection process of Step 408, two kind of detection results may be obtained. If it is detected that there exists a certain data transmission task in the first chip, Step 409 is executed. If it is detected that there exists no data transmission task in the first chip, Step 410 is executed.

Step 409: if it is detected that there exists a certain data transmission task in the first chip, it is determined that the first chip is kept in a working state.

If it is detected that there exists a certain data transmission task in the first chip, it is indicated that data interaction still exists between the first chip and the second chip or another chip. It is determined that the first chip is kept in the working state.

Step 410: if it is detected that there exists no data transmission task in the first chip, it is determined that the first chip enters a sleep state.

If it is detected that there exists no data transmission task in the first chip, it is indicated that there exists no data interaction between the first chip and the second chip or with another chip. It is determined that the first chip enters the sleep state.

Typically, when a peripheral chip is in the working state, an RTS pin of the peripheral chip is in the effective state all the time. When the interference signal exists in the master chip, an RXD pin in the peripheral chip may receive an interference signal from the master chip, which may cause a working abnormity of the peripheral chip. From the above, according to the pin control method provided by the embodiment, when the sleep pin of the first chip receives the transmission completion signal sent by the second chip, the first RTS pin is set into the ineffective state according to the transmission completion signal, avoiding the working abnormity of the peripheral chip. When the sleep pin receives the transmission completion signal sent by the second chip, the first RTS pin is set into the ineffective state, which makes that the RXD pin on the first chip may not receive an interference signal existing in the second chip, no matter whether the first chip enters the sleep state. The condition of working abnormity of the first chip due to reception of the interference signal in the second chip is avoided.

Further, in the embodiment shown in FIG. 4A, the first chip is a master chip, and the second chip is any one of a Bluetooth chip, a Wi-Fi chip, a radio frequency chip, a power chip, an LED chip and an audio and video chip. Or, the first chip is any one of the Bluetooth chip, the Wi-Fi chip, the radio frequency chip, the power chip, the LED chip and the audio and video chip, and the second chip is the master chip.

In an exemplary example, as shown in FIG. 4B, it is supposed that a first chip is a Bluetooth chip and a second chip is a master chip. The first RTS pin is the RTS pin in the Bluetooth chip, the first CTS pin is the CTS pin in the Bluetooth chip, the first RXD pin is the RXD pin in the Bluetooth chip, the first TXD pin is the TXD pin in the Bluetooth chip and the sleep pin is the SLEEP pin in the Bluetooth chip. The second RTS pin is the RTS pin in the master chip, the second CTS pin is the CTS pin in the master chip, the second RXD pin is the RXD pin in the master chip, the second TXD pin is the TXD pin in the master chip and the wakeup pin is the Wake bt pin in the master chip. A specific pin control method includes that: when the master chip is required to send data to the Bluetooth chip, a data sending signal is sent to the Bluetooth chip through the Wake bt pin at first, and the Bluetooth chip sets the first RTS pin into an effective state according to the data sending signal; when the second CTS pin of the master chip detects that the first RTS pin is in the effective state, the master chip sends the data to the Bluetooth chip through the second TXD pin, and the Bluetooth chip receives the data through the first RXD pin; and when the master chip completes data sending, a transmission completion signal is sent to the Bluetooth chip through the Wake bt pin, and the Bluetooth chip sets the first RTS pin into an ineffective state according to the transmission completion signal, and determines according to a current running condition whether to enter a sleep state. In some embodiments, the Bluetooth chip may also include a Data Set Ready (DSR) pin, a Volt Current Condenser (VCC) pin and a Ground (GND) pin. The master chip may also include: a DSR pin, a Data Carrier Detect (DCD) pin, a VCC pin, a GND pin, a Universal Serial Bus (USB) pin, a Clock (CLK) pin and a Signal Ground (SG) pin.

Below is a device embodiment of the present disclosure, which may be configured to execute the method embodiment of the present disclosure. Details undisclosed in the device embodiment of the present disclosure refer to the method embodiment of the present disclosure.

FIG. 5 is a block diagram of a pin control device, according to an exemplary embodiment. As shown in FIG. 5, the pin control device is applied to a first chip 120 in an implementation environment shown in FIG. 1. The pin control device includes, but not limited to:

a first receiving module 520 configured to, when a sleep pin receives a data sending signal sent by a second chip, set a first RTS pin into an effective state according to the data sending signal, the sleep pin being a pin connected with a wakeup pin on the second chip and the first RTS pin being a pin connected with a second CTS pin on the second chip;

a data receiving module 540 configured to receive data sent by the second chip through a first RXD pin, the first RXD pin being in the effective state when the first RTS pin is in the effective state and the first RXD pin being a pin connected with a second TXD pin on the second chip;

a second receiving module 560 configured to, when the sleep pin receives a transmission completion signal sent by the second chip, set the first RTS pin into an ineffective state according to the transmission completion signal; and

a state determination module 580 configured to determine according to a current running condition whether to enter a sleep state.

Typically, when a peripheral chip is in the working state, an RTS pin of the peripheral chip is in the effective state all the time. When the interference signal exists in the master chip, an RXD pin in the peripheral chip may receive an interference signal from the master chip, which may cause a working abnormity of the peripheral chip. From the above, according to the pin control device provided by the embodiment, when the sleep pin of the first chip receives the transmission completion signal sent by the second chip, the first RTS pin is set into the ineffective state according to the transmission completion signal, avoiding the working abnormity of the peripheral chip. When the sleep pin receives the transmission completion signal sent by the second chip, the first RTS pin is set into the ineffective state, which makes that the RXD pin on the first chip may not receive an interference signal existing in the second chip, no matter whether the first chip enters the sleep state. The condition of working abnormity of the first chip due to reception of the interference signal in the second chip is avoided.

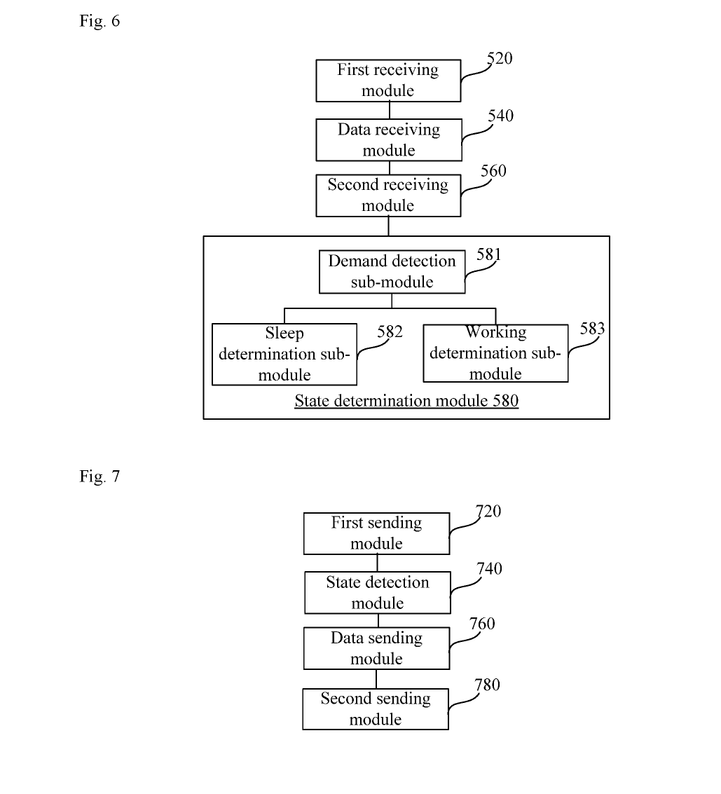

FIG. 6 is a block diagram of a pin control device, according to another exemplary embodiment. As shown in FIG. 6, the pin control device is applied to a first chip 120 in an implementation environment shown in FIG. 1. The pin control device includes, but not limited to the following modules.

A first receiving module 520 is configured to, when a sleep pin receives a data sending signal sent by a second chip, set a first RTS pin into an effective state according to the data sending signal, the sleep pin being a pin connected with a wakeup pin on the second chip and the first RTS pin being a pin connected with a second CTS pin on the second chip.

In some embodiments, the first receiving module 520 is further configured to, when the sleep pin is changed from a first level to a second level, set the first RTS pin into a third level, the third level being configured to represent that the first RTS pin is in the effective state.

Wherein, the first level is a high level and the second level is a low level. Or, the first level is a low level and the second level is a high level. And the third level is a high level or a low level.

A data receiving module 540 is configured to receive data sent by the second chip through a first RXD pin, the first RXD pin being in the effective state when the first RTS pin is in the effective state and the first RXD pin being a pin connected with a second TXD pin on the second chip.

A second receiving module 560 is configured to, when the sleep pin receives a transmission completion signal sent by the second chip, set the first RTS pin into an ineffective state according to the transmission completion signal.

In some embodiments, the second receiving module 560 is further configured to, when the sleep pin is changed from the second level to the first level, set the first RTS pin into a fourth level, the fourth level being configured to represent that the RTS pin is in the ineffective state.

Wherein, the first level is a high level and the second level is a low level, or, the first level is a low level and the second level is a high level; and the third level is a high level or a low level.

A state determination module 580 is configured to determine according to a current running condition whether to enter a sleep state.

In some embodiments, the state determination module 580 includes: a demand detection sub-module 581, a sleep determination sub-module 582 and a working determination sub-module 583.

The demand detection sub-module 581 is configured to detect whether there exists a data transmission task with the second chip or another chip.

The sleep determination sub-module 582 is configured to, if there exists no data transmission task, determine to enter the sleep state.

The working determination sub-module 583 is configured to, if there exists a certain data transmission task, determine to keep a working state.

In some embodiments, the first chip is a master chip, and the second chip is any one of a Bluetooth chip, a Wi-Fi chip, a radio frequency chip, a power chip, an LED chip and an audio and video chip. Or, the first chip is any one of the Bluetooth chip, the Wi-Fi chip, the radio frequency chip, the power chip, the LED chip and the audio and video chip, and the second chip is the master chip.

Typically, when a peripheral chip is in the working state, an RTS pin of the peripheral chip is in the effective state all the time. When the interference signal exists in the master chip, an RXD pin in the peripheral chip may receive an interference signal from the master chip, which may cause a working abnormity of the peripheral chip. From the above, according to the pin control device provided by the embodiment, when the sleep pin of the first chip receives the transmission completion signal sent by the second chip, the first RTS pin is set into the ineffective state according to the transmission completion signal, and whether to enter the sleep state is determined according to the current running condition, avoiding the working abnormity of the peripheral chip. When the sleep pin receives the transmission completion signal sent by the second chip, the first RTS pin is set into the ineffective state, which makes that the RXD pin on the first chip may not receive an interference signal existing in the second chip, no matter whether the first chip enters the sleep state. The condition of working abnormity of the first chip due to reception of the interference signal in the second chip is avoided.

FIG. 7 is a block diagram of a pin control device, according to an exemplary embodiment. As shown in FIG. 7, the pin control device is applied to a second chip 140 in an implementation environment shown in FIG. 1. The pin control device includes, but not limited to:

a first sending module 720 configured to send a data sending signal to a first chip through a wakeup pin, the wakeup pin being a pin connected with a sleep pin on the first chip;

a state detection module 740 configured to detect, by using a second CTS pin whether a first RTS pin on the first chip is in an effective state, the second CTS pin being a pin connected with the first RTS pin on the first chip;

a data sending module 760 configured to, if the first RTS pin on the first chip is in the effective state, send data to the first chip through a second TXD pin, the second TXD pin being a pin connected with a first RXD pin on the first chip; and

a second sending module 780 configured to, when data transmission is completed, send a transmission completion signal to the first chip through the wakeup pin for the first chip to set the first RTS pin into an ineffective state according to the transmission completion signal and to determine according to a current running condition whether to enter a sleep state.

Typically, when a peripheral chip is in the working state, an RTS pin of the peripheral chip is in the effective state all the time. When the interference signal exists in the master chip, an RXD pin in the peripheral chip may receive an interference signal from the master chip, which may cause a working abnormity of the peripheral chip. From the above, according to the pin control device provided by the embodiment, when data transmission is completed, the transmission completion signal is sent to the first chip through the wakeup chip, thereby the first chip sets the RTS pin into the ineffective state according to the transmission completion signal and determines according to the current running condition whether to enter the sleep state, avoiding the working abnormity of the peripheral chip. When a sleep pin of the first chip receives the transmission completion signal sent by the second chip, the first RTS pin is set into the ineffective state, which makes that the RXD pin on the first chip may not receive an interference signal existing in the second chip, no matter whether the first chip enters the sleep state. The condition of working abnormity of the first chip due to reception of the interference signal in the second chip is avoided.

Based on the pin control device shown in FIG. 7, the first sending module 720 is further configured to, when the wakeup pin is changed from a first level to a second level, send the data sending signal to the first chip through the wakeup pin.

Wherein, the first level is a high level and the second level is a low level. Or, the first level is a low level and the second level is a high level.

In some embodiments, the state detection module 740 is further configured to detect, by using the second CTS pin, whether the first RTS pin on the first chip is a third level, the third level being configured to represent that the first RTS pin is in the effective state and the third level being a high level or a low level.

In some embodiments, the second sending module 780 is further configured to, when the wakeup pin is changed from the second level to the first level, send the transmission completion signal to the first chip through the wakeup pin.

Wherein, the first level is a high level and the second level is a low level. Or, the first level is a high level and the second level is a high level.

In some embodiments, the first chip is a master chip, and the second chip is any one of a Bluetooth chip, a Wi-Fi chip, a radio frequency chip, a power chip, an LED chip and an audio and video chip; or, the first chip is any one of the Bluetooth chip, the Wi-Fi chip, the radio frequency chip, the power chip, the LED chip and the audio and video chip, and the second chip is the master chip.

With respect to the devices in the above embodiments, the specific manners for performing operations for individual modules therein have been described in detail in the embodiments regarding the methods, which will not be elaborated herein.

It will be appreciated by those skilled in the art that all or part of the steps of the abovementioned embodiment may be implemented by hardware, and may also be implemented by related hardware instructed by a program, the program may be stored in a computer-readable storage medium, and the abovementioned storage medium may be a read-only memory, a magnetic disk, an optical disk or the like.

The above is only the preferred embodiment of the present disclosure and not intended to limit the present disclosure. Any modification, equivalent replacement, improvement and the like made within the spirit and principle of the present disclosure shall fall within the scope of protection of the present disclosure.

What is claimed is:

1. A pin control method, applied to a first chip comprising a sleep pin connected with a wakeup pin on a second chip, a Request To Send (RTS) pin connected with a Clear To Send (CTS) pin on the second chip, a Receive Data (RXD) pin connected with a Transmit Data (TXD) pin on the second chip, the method comprising:
receiving, by the sleep pin, a data sending signal sent by the second chip;
setting the RTS pin into an effective state according to the data sending signal;
receiving, by the RXD pin, data sent by the second chip, the RXD pin being in the effective state when the RTS pin is in the effective state;
receiving, by the sleep pin, a transmission completion signal sent by the second chip;
setting the RTS pin into an ineffective state according to the transmission completion signal; and
determining, according to a current running condition, whether to enter a sleep state.

2. The method according to claim 1, wherein setting the RTS pin into the effective state according to the data sending signal comprises:
setting the RTS pin into a third level when the sleep pin is changed from a first level to a second level, wherein the first level is a high level and the second level is a low level, or, the first level is a low level and the second level is a high level; and the third level is a high level or a low level.

3. The method according to claim 1, wherein setting the RTS pin into the ineffective state according to the transmission completion signal comprises:
setting the RTS pin into a fourth level when the sleep pin is changed from the second level to the first level, wherein the first level is a high level and the second level is a low level, or, the first level is a low level and the second level is a high level; and the third level is a high level or a low level.

4. The method according to claim 1, wherein determining according to the current running condition whether to enter the sleep state comprises:
detecting whether there exists a data transmission task with the second chip or another chip;
determining to enter the sleep state if the data transmission task does not exist;
determining to keep a working state if the data transmission task exists.

5. The method according to claim 1, wherein the first chip is a master chip, and the second chip is any one of a Bluetooth chip, a Wireless-Fidelity (Wi-Fi) chip, a radio frequency chip, a power chip, a Light Emitting Diode (LED) chip and an audio and video chip.

6. The method according to claim 1, wherein the first chip is any one of a Bluetooth chip, a Wi-Fi chip, a radio frequency chip, a power chip, a LED chip and an audio and video chip, and the second chip is a master chip.

7. The method according to claim 1, applied to a second chip comprising a wakeup pin connected with a sleep pin on a first chip, a CTS pin connected with a RTS pin on the first chip, a TXD pin connected with a RXD pin on the first chip, the method further comprising:
sending, by the wakeup pin, a data sending signal to the first chip;
detecting, by the CTS pin, whether the RTS pin is in an effective state;
sending, by the TXD pin, data to the first chip if the RTS pin is in the effective state; and
when data transmission is completed, sending, by the wakeup pin, a transmission completion signal to the first chip for:
setting the RTS pin into an ineffective state according to the transmission completion signal and
determining, according to a current running condition, whether to enter a sleep state.

8. The method according to claim 7, wherein detecting, by the CTS pin, whether the RTS pin is in the effective state comprises:
detecting, by the CTS pin, whether the RTS pin on the first chip is a third level, the third level being a high level or a low level.

9. A pin control device, applied to a first chip comprising a sleep pin connected with a wakeup pin on a second chip, a RTS pin connected with a CTS pin on the second chip, a RXD pin connected with a TXD pin on the second chip, the device comprising:
a processor; and
a memory configured to store instructions executable by the processor;
wherein the processor is configured to:
receive, by the sleep pin, a data sending signal sent by the second chip;
set the RTS pin into an effective state according to the data sending signal;
receive, by the RXD pin, data sent by the second chip, the RXD pin being in the effective state when the RTS pin is in the effective state;
receive, by the sleep pin, a transmission completion signal sent by the second chip;
set the RTS pin into an ineffective state according to the transmission completion signal; and
determine, according to a current running condition, whether to enter a sleep state.

10. The device according to claim 9, wherein the processor configured to set the RTS pin into the effective state according to the data sending signal is further configured to:
set the RTS pin into a third level when the sleep pin is changed from a first level to a second level, wherein the first level is a high level and the second level is a low level, or, the first level is a low level and the second level is a high level; and the third level is a high level or a low level.

11. The device according to claim 9, wherein the processor configured to set the RTS pin into the ineffective state according to the transmission completion signal is further configured to:
set the RTS pin into a fourth level when the sleep pin is changed from the second level to the first level, wherein the first level is a high level and the second level is a low level, or, the first level is a low level and the second level is a high level; and the third level is a high level or a low level.

12. The device according to claim 9, wherein the processor configured to determine, according to the current running condition, whether to enter the sleep state is further configured to:
detect whether there exists a data transmission task with the second chip or another chip;
determine to enter the sleep state if the data transmission task does not exist;
determine to keep a working state if the data transmission task exists.

13. The device according to claim 9, wherein the first chip is a master chip, and the second chip is any one of a Bluetooth chip, a Wi-Fi chip, a radio frequency chip, a power chip, a LED chip and an audio and video chip.

14. The device according to claim 9, wherein the first chip is any one of a Bluetooth chip, a Wi-Fi chip, a radio frequency chip, a power chip, a LED chip and an audio and video chip, and the second chip is a master chip.

15. A pin control device, applied to a second chip comprising a wakeup pin connected with a sleep pin on a first chip, a CTS pin connected with a RTS pin on the first chip, a TXD pin connected with a RXD pin on the first chip, the device comprising:
a processor; and
a memory configured to store instructions executable by the processor;
wherein the processor is configured to:
send, by the wakeup pin, a data sending signal to the first chip;
detect, by the CTS pin, whether the RTS pin is in an effective state;
send, by the TXD pin, data to the first chip if the RTS pin is in the effective state; and
when data transmission is completed, send, by the wakeup pin, a transmission completion signal to the first chip for:
setting the RTS pin into an ineffective state according to the transmission completion signal and
determining, according to a current running condition, whether to enter a sleep state.

16. The device according to claim 15, wherein the processor configured to detect, by the CTS pin, whether the RTS pin is in the effective state is further configured to:
detect, by the CTS pin, whether the RTS pin on the first chip is a third level, the third level being a high level or a low level.

17. The device according to claim 15, wherein the processor configured to send, by the wakeup pin, the data sending signal to the first chip is further configured to:
send, by the wakeup pin, the data sending signal to the first chip when the wakeup pin is changed from a first level to a second level, wherein the first level is a high level and the second level is a low level, or, the first level is a low level and the second level is a high level.

18. The device according to claim 15, wherein the processor configured to send, by the wakeup pin, the transmission completion signal to the first chip when the data transmission is completed is further configured to:
send, by the wakeup pin, the transmission completion signal to the first chip when the wakeup pin is changed from the second level to the first level, wherein the first level is a high level and the second level is a low level, or, the first level is a high level and the second level is a high level.

19. The device according to claim 15, wherein the first chip is a master chip, and the second chip is any one of a Bluetooth chip, a Wi-Fi chip, a radio frequency chip, a power chip, a LED chip and an audio and video chip.

20. The device according to claim 15, wherein the first chip is any one of a Bluetooth chip, a Wi-Fi chip, a radio frequency chip, a power chip, a LED chip and an audio and video chip, and the second chip is a master chip.
